(19) United States
(12) Patent Application Publication
(10) Pub. No.: US 2003/0154129 A1
(43) Pub. Date: Aug. 14, 2003

(54) Methods and systems for marketing comparable products

(75) Inventor: Joshua Goff, San Diego, CA (US)

Correspondence Address: Finnegan, Henderson, Farabow,, Garrett & Dunner, L.L.P., 1300 I Street, N.W., Washington, DC, 20005-3315, US

(73) Assignee: Capital One Financial Corporation

(21) Appl. No.: 10/287,610

(22) Filed: Nov. 5, 2002

Related U.S. Application Data
(60) Provisional application No. 60/355,797, filed on Feb. 12, 2002.

(51) Int. Cl. G06F 17/60

(52) U.S. Cl. 705/14; 705/10

(57) ABSTRACT

Methods and systems consistent with the present invention enable a computing system to determine whether a user may purchase a first product. Further, a marketing value associated with the user is determined that reflects a likelihood of the user purchasing a second product which is comparable to the first product. Based on the marketing value, the computing system may generate an offer associated with the second product that and provide the offer to the user, wherein the offer includes a purchase incentive associated with the second product which may not otherwise be available to the user.

### CROSS REFERENCE TO RELATED APPLICATION

This application claims the benefit of U.S. Provisional Patent Application No. 60/355,797, filed Feb. 12, 2002, the disclosure of which is expressly incorporated herein by reference in its entirety.

### BACKGROUND OF THE INVENTION

1. Field of the Invention

Methods and systems consistent with the present invention relate to marketing services, and more particularly, to environments that market comparable products to a user.

2. Background and Material Information

Manufacturers use various marketing strategies to solicit their products to potential customers. One such marketing strategy, known as target advertising, enables a manufacturer to target an audience to market their products based on a plurality of criteria, such as user profiles that may be purchased from third party sources (e.g., mailing lists). The manufacturer may then solicit their products to the target audience in the form of advertisements.

Although target advertising enables manufacturers to deliver product information to potentially interested customers, it does have some shortcomings. For example, competing manufacturers may employ the same marketing strategies. That is, while one manufacturer may be marketing a particular product to a group of customers, a competitor may market a comparable product to the same group. Another disadvantage of typical marketing strategies is the cost of advertising a product in comparison with a return in sales. For instance, although a manufacturer may market their products to a group of potential customers, the manufacturer does not have knowledge of whether the customers are actually considering purchasing a product similar to the manufacturer's product. Accordingly, manufacturers may allot large budgets for advertising their product to customers that may not even be “in the market” for such products.

Accordingly, there is a need for determining a customer's intent to purchase a product and market a comparable product to the customer based on the determination.

### SUMMARY OF THE INVENTION

Methods and systems consistent with the present invention enable a computing system to determine whether a user is considering to purchase a first product and determine a marketing value associated with the user. Based on the marketing value, the computing system may generate an offer associated with a second product that is comparable to the first product and provide the offer to the user, wherein the offer includes a benefit that is otherwise not available to the user.

Both the foregoing general description and the following detailed description are exemplary and are intended to provide further explanation of the embodiments of the invention as claimed.

### BRIEF DESCRIPTION OF THE DRAWINGS

The accompanying drawings, which are incorporated in and constitute a part of this specification, illustrate various embodiments and aspects of the present invention and, together with the description, explain the principles of the invention. In the drawings:

FIG. 1 illustrates an exemplary system environment in which certain embodiments of the present invention may be implemented;

FIG. 2 shows a block diagram of an exemplary notification system consistent with an embodiment of the present invention;

FIG. 3 is a flowchart of an exemplary notification process consistent with an embodiment of the present invention;

FIG. 4 is a block diagram of an exemplary ranking data structure consistent with an embodiment of the present invention;

FIG. 5 shows a screen shot of an exemplary loan application with a product information query consistent with an embodiment of the present invention;

FIGS. 6A and 6B show exemplary brand reinforcement notifications consistent with an embodiment of the present invention;

FIGS. 7A and 7B show exemplary conquest notifications consistent with an embodiment of the present invention; and

FIG. 8 is a flowchart of an exemplary tracking process consistent with an embodiment of the present invention.

### DETAILED DESCRIPTION

Overview

The present invention is directed to methods, systems, and articles of manufacture for identifying a potential buyer of a product and presenting information associated with the product or a comparable product to the buyer based on a determination that the potential buyer may purchase the product. In one embodiment, a notification system is provided that determines whether a user (e.g., potential buyer) may purchase a first product. Based on the determination, the system may determine a marketing value reflecting a likelihood of the user purchasing a product offered by a manufacturer that is comparable to the first product. The marketing value may be determined based the type of the first product and profile information associated with the user, such as address information, income, age, etc. Once the marketing value has been determined, the system may enter the user in a ranking data structure including information associated with a plurality of other users and their corresponding marketing values. The data structure may be configured into segments that each reflect various ranges of marketing values. Accordingly, the user may be associated with a segment of the ranking data structure based on the corresponding marketing value of the user.

The notification system may also perform a marketing process that determines a type of offer and channel to provide the offer (e.g., delivery medium, such an electronic medium, telephonic medium, etc.). An offer is a notification that includes information on a product provided by a manufacturer that the notification system is configured to provide marketing services. The product information may include, for example, a discount on the offered product that is comparable to the first product. In one embodiment, the marketing process may include determining a return value associated with each segment in the data structure. A return value may represent a monetary return value that the notification system (or an entity affiliated therewith) may receive for providing an offer to a user included in the respective segment. Further, the notification system may also determine a cost value associated with providing an offer to a user through one or more channels. For example, it may take more resources by the notification system to provide an offer to a user through a telemarketing medium as opposed to an electronic medium. Moreover, the notification system may also determine an effectiveness value for each channel based on historical information associated with each channel—electronic mediums may have been more effective than other mediums in the past in obtaining a response from a user to purchase a comparable product included in an offer. Based on the determined marketing value, return value, channel costs, effectiveness value, and product information associated with the offered product and first product, the notification system may determine a type of offer and channel to provide the offer to the user.

Further, embodiments of the present invention enable a notification system to track offers provided to one or more users (e.g., potential buyers) and to charge manufacturers a fee based on the provided offers.

The above-noted features and other aspects and principles of the present invention may be implemented in various environments. Such environments and related applications may be specially constructed for performing the various processes and operations of the invention or they may include a general purpose computer or computing platform selectively activated or reconfigured by program code to provide the necessary functionality. The processes disclosed herein are not inherently related to any particular computer or other apparatus, and aspects of these processes may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

The present invention also relates to computer readable media that include program instructions or program code for performing various computer-implemented operations based on the methods and processes of the invention. The program instructions may be those specially designed and constructed for the purposes of the invention, or they may be of the kind well-known and available to those having skill in the computer software arts. Examples of program instructions include for example machine code, such as produced by a compiler, and files containing a high level code that can be executed by the computer using an interpreter.

Exemplary System Environments and Processes

Reference will now be made in detail to embodiments of the present invention, examples of which are illustrated in the accompanying drawings. Wherever possible, the same reference numbers will be used throughout the drawings to refer to the same or like parts.

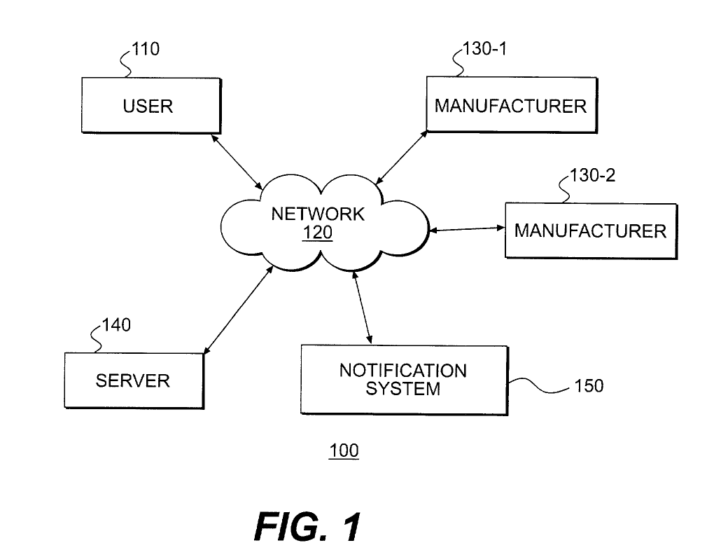

FIG. 1 illustrates an exemplary system environment 100 in which embodiments of the invention may be implemented. As illustrated in FIG. 1, environment 100 includes a user 110, network 120, manufacturers 130-1 and 130-2, server 140, and notification system 150.

User 110 may be a desktop computer, workstation, laptop, personal digital assistant or any other similar computing system known in the art that is associated with an individual, group of individuals, a business entity or entities. User 110 may be equipped with browser software such as Netscape Navigator, Microsoft Internet Explorer, or any other known browser software that enable user 110 to access and communicate with remote entities attached to network 120. User 110 may also include other communication systems and/or devices, such as wireline and wireless telephone devices, that enable user 110 to communicate with remote entities, such as manufacturers 130-1 and 130-2, server 140, and notification system 150. Additionally, user 110 may be an individual or group of individuals that interact with notification system 140 and/or manufacturers 130-1 and 130-2 through mediums other than network 120. For example, user 110 may interact with manufacturers 130-1, 130-2 and/or notification system 150 through conventional mail services (e.g., United States Postal Services). Although FIG. 1 shows only a single user 110, one skilled in the art would recognize that additional users 110 may be implemented in computing environment 100 without departing from the scope of the present invention.

Network 120 may be any type of network that facilitates communications and data transfer between user 110, manufacturers 130-1 and 130-2, server 140, and notification system 150. Network 120 may be a Local Area Network (LAN), a Wide Area Network (WAN), such as the Internet, and may be a single network or combination of networks. Further, network 120 may reflect a single type of network, a combination of different types of networks, such as the Internet and public exchange networks for wireline and/or wireless communications. One skilled in the art would recognize that network 120 is not limited to the above examples and that computing environment 100 may implement any type of network that allows the entities (and others not shown) included in FIG. 1 to exchange data.

Manufacturers 130-1 and 130-2 may each be a computer system, such as a workstation, desktop computer, server, mainframe, or any other type of computer system that includes known computer system components for processing data and communicating with network 120 and/or other remote entities, such as user 110, server 140, and notification system 150. In one embodiment, manufacturers 130-1 and 130-2 may each be associated with a business entity that provides particular products and/or services. For example, manufacturer 130-1 may be associated with an automobile manufacturer (e.g., Ford™)and manufacturer 130-2 may be associated with a competing business entity that also provides or markets vehicles (e.g., Toyota™). Alternatively, manufacturer 130-1 may be associated with a business entity that provides one or more types of products that are unrelated to products provided by manufacturer 130-2. Further, manufacturers 130-1 and 130-2 may each be associated with a business entity that provides particular services, such as contracting services (e.g., plumbing), financial planning services, medical services, and any other type of service that may be sold to user 110. Accordingly, one skilled in the art would appreciate that manufacturers 130-1 and 130-2 may each be associated with an entity that manufactures, develops, provides, markets, and/or distributes any type of product and/or service that may be offered and/or sold to user 110. For exemplary purposes, manufacturers 130-1 and 130-2 are described herein as being associated with a business entity that provides vehicles, such as cars and/or trucks. It should be noted, however, that manufacturers 130-1 and 130-2 is not limited to an association with a vehicle manufacturer and that any type of entity that provides any type of product or service that may be offered and/or sold to user 100 may be associated with manufacturers 130-1 and 130-2 without departing from the scope of the invention. Moreover, although FIG. 1 shows two manufacturers 130-1 and 130-2, system environment 100 may include more or fewer manufacturers without departing from the scope of the present invention.

Server 140 may be a computer system that is configured to provide content to remote entities through network 120. In one embodiment, server 140 may be configured to maintain one or more web pages that includes content. The content may be provided by server 140 or by remote entities, such as notification system 150. Remote entities may access server 140 through network 120 using any type of network communication protocol. For example, user maybe configured to access server 140 using a browser program running on a computer system local to user 110. Server 140 may configure content on a web page requested by user 110 and provide the content to the browser program through network 120. One skilled in the art would appreciate that server 140 is not limited to web server operations, and that based on the configuration of system environment 100, various types of data may be provided to remote entities by server 140, such as non-web based information. Further, server 140 may be configured to communicate directly with other remote entities, such as notification system 150. In one embodiment, server 140 may be a server that is dedicated to perform operations for notification system 150 and provide data to remote entities.

Notification system 150 may be a computer system, such as a workstation, desktop computer, server, mainframe, or any other type of computer system that includes known computer system components for processing data and communicating with network 120 and/or other remote entities, such as user 110, server 140, and manufacturers 130-1 and 130-2. In one embodiment of the invention, system 150 may be configured to determine a user's intention to purchase a particular type of product provided by a particular manufacturer and, based on that determination, provide a notification to the user of a comparable product offered by the manufacturer or another manufacturer. Further, system 150 may be configured to monitor the number of product notifications provided to one or more users and charge one or more manufacturers of the product a fee based on the number of provided notifications.

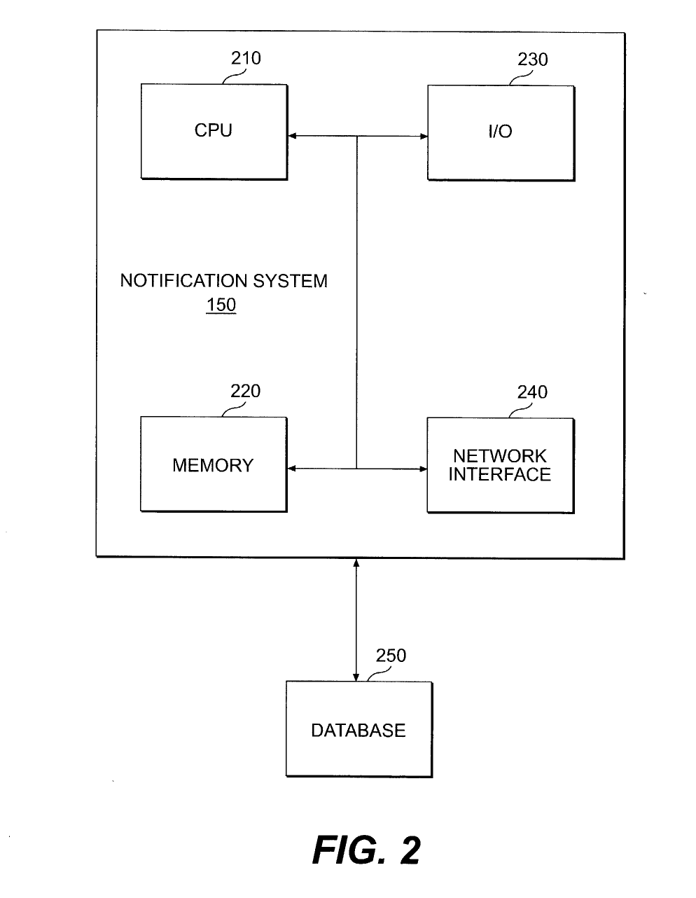

FIG. 2 shows a block diagram of notification system 150 consistent with an embodiment of the present invention. As shown, system 150 may include CPU 210, memory 220, Input/Output device (“I/O”) 230, and network interface 240. Further, notification system may be connected to a database 250.

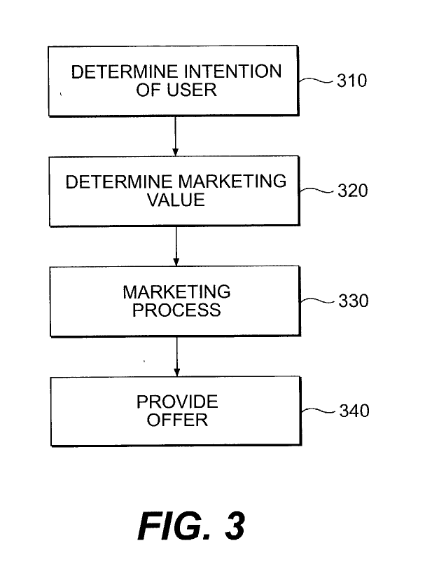

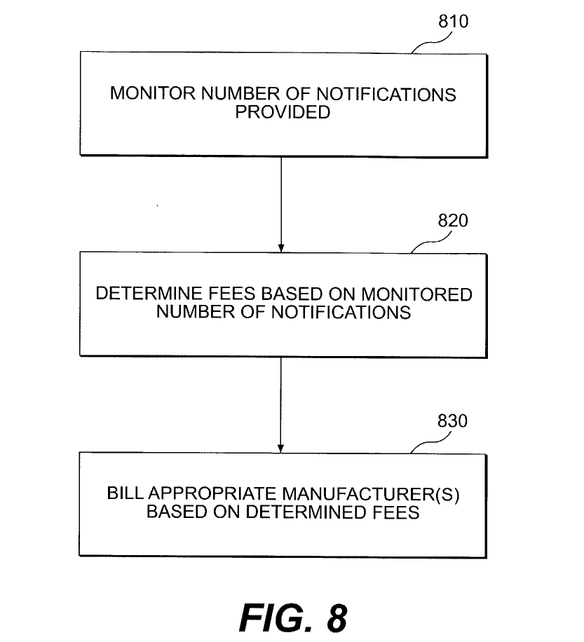

CPU 210 may be one or more known processing devices, such as a microprocessor from the Pentium family manufactured by Intel™. Memory 220 may be one or more storage devices configured to store information used by CPU 210 to perform certain functions related to the present invention. Memory 220 may be a magnetic, semiconductor, tape, or optical type of storage device. In one embodiment, memory 220 includes one or more programs that, when executed by CPU 210, perform various functions associated with certain embodiments of the present invention. For instance, memory 220 may include: a program for determining an intention of user 110 to purchase a type of product and/or service from a manufacturer (e.g., 130-1, 130-2); a program for generating, modifying, and maintaining one or more ranking data structures including one or more segments each associated with one or more users (i.e., customers); a program for determining a marketing value for each user reflecting a likelihood of the corresponding user purchasing a particular product; a program for determining a type of offer to provide to a user; and a program for generating and delivering the determined offer to the user. Moreover, memory 220 may include a program for monitoring and determining the number of offers provided to one or more users by system 150 and determining a fee to charge one or more manufacturers associated with the monitored offers. The functions performed by the above mentioned programs are described further below with respect to FIGS. 3 and 8.

Further, it should be noted that memory 220 may also include other programs that perform other functions consistent with embodiments of the invention. Moreover, methods, systems, and articles of manufacture consistent with embodiments of the present invention are not limited to programs configured to perform dedicated tasks. For example, memory 220 may be configured with a program that performs several functions when executed by CPU 210. That is, memory 220 may include a program for determining an intention of a user and for updating, maintaining, and/or generating one or more rank based data structures, and may include another program for determining a type of notification and delivering the offer to the user. Alternatively, CPU 210 may execute one or more programs located remotely from system 150. For example, system 150 may access remote programs that, when executed, perform functions related to embodiments of the present invention.

I/O device 230 may be one or more input/output devices that allow data to be received and transmitted from/to system 150. For example, I/O device 230 may include one or more input devices, such as a keyboard, touchscreen, mouse, etc. that enable data to be input from a user operating system 150. Further, I/O device 230 may include one or more output devices, such as a display screen, printer, speaker devices, etc. that enable data to be output to a user operating system 150. The configuration and number of input and/or output devices incorporated in I/O device 230 may vary without departing from the scope of the invention.

Network interface 240 may be any known network interface device that enables data to be exchanged between notification system 150 and a connected network, such as network 120. Database 250 may be one or more database storage devices that maintain information used by notification system 150 to perform various functions related to embodiments of the invention. For example, in one embodiment, database 250 may be configured to store one or more rank based data structures generated by a program executed by CPU 210.

System environment 100 may allow notification system 150 to provide marketing services to a particular manufacturer (e.g., manufacturer 130-2) based on a determined intention of user 110 to purchase a product and/or service from the particular manufacturer or a competing manufacturer (e.g., manufacturer 130-1). The marketing services may include providing an offer for a comparable product and/or service provided by the manufacturer (e.g., manufacturer 130-2). FIG. 3 shows a flowchart of an exemplary notification process that may be performed by methods, systems, and articles of manufacture consistent with embodiments of the present invention. Although the notification process is described with a particular type of product (e.g., vehicle), the following description applies to other types of products and/or services.

The notification process shown in FIG. 3 may begin when notification system 150 determines a likelihood or possible intention of user 110 of purchasing a type of product from a manufacturer, for example manufacturer 130-1 (Step 310). Notification system 150 may determine that user 110 intends to purchase a particular type of product based on information provided directly from the user 110. For example, notification system 150 may be associated with a financial account provider that provides financial services to the user, such as loans, checking and savings accounts, etc. User 110 may request a loan from the financial account provider for various reasons, such as to purchase a particular product (e.g., an automobile). Accordingly, the financial account provider may request product specific information from user 110 as part of the loan application. For example, user 110 may provided product information in a loan application that includes a query associated with the particular type of product user 110 plans on purchasing with the proceeds from an approved loan. Therefore, if user 110 is requesting an automobile loan, the loan application provided by the financial account provider may include one or more queries that request the make, model, and/or class (e.g., luxury, non-luxury, etc.) of a desired automobile that user 110 is interested in purchasing. The financial account provider may forward the product specific information to notification system 150 for processing in order to determine the type of product user 110 intends to purchase.

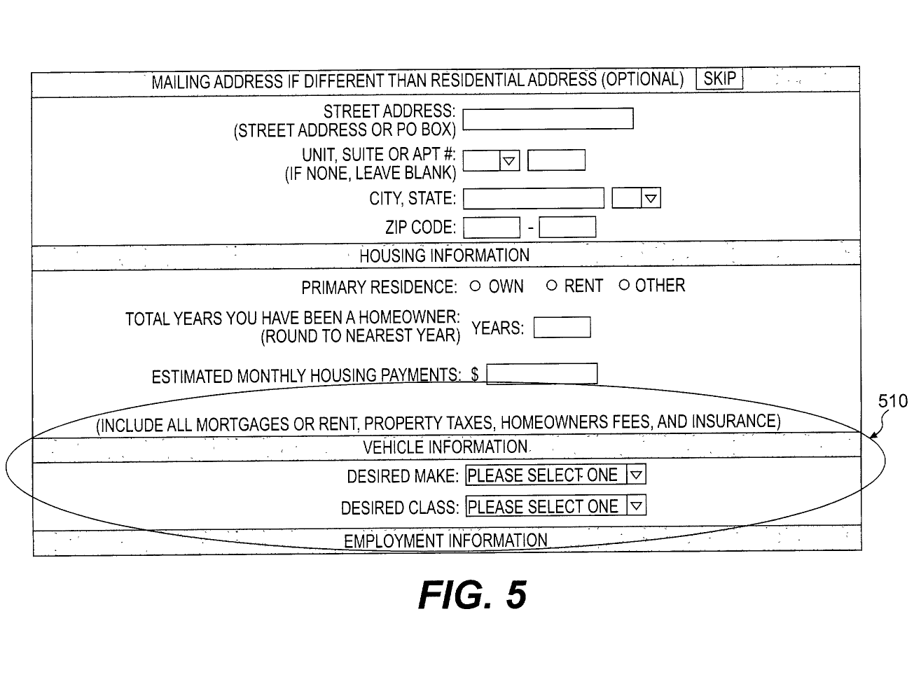

In the above example, the financial account provider may receive the loan application information that user 110 provides through various channels (e.g., mediums). In one embodiment, the financial account provider may host a web site (directly or through server 140) that allows user 110 to fill out a loan application while visiting the web site over network 120. Therefore, the financial account provider may include queries for product specific information, such as automobile make, model, and class, in an on-line application. FIG. 5 shows a screen shot of an exemplary loan application with a vehicle information query 510.

Alternatively, user 110 may apply for a loan using conventional mail services, such as the United States Postal Service. In this alternate embodiment, the financial account provider may provide a loan application document that is filled out and returned by user 110. Additionally, user 110 may apply for a loan, and provide the product specific information, using a telephone-based device, such as a landline or wireless telephone. Accordingly, the financial account provider may include the infrastructure necessary to process, manage, and perform the loan application processes in any of the above exemplary mediums.

In another embodiment of the present invention, notification system 150 may receive product specific information from user 110 through surveys that are provided by a business entity associated with system 150 or third party sources, such as a survey business that generates and processes surveys to selected groups of users. The product specific information may be provided to notification system 150 via network 120. Alternatively, the business entity associated with system 150 may receive the product specific information from the third party source using other mediums, such as conventional mail. In such an example, the business entity processes the product specific information in a format that is compatible with notification system 150. In another embodiment, manufacturer 130-1, 130-2 may provide product specific information associated with an intended purchase by user 110 to notification system 150. Further, notification system 150 may determine user intent by detecting when a user clicks through a link presented on a document that represents an advertisement for a product. Accordingly, when the user selects the link, notification system 150 may associate the selection as an intention of the user to purchase a product corresponding to the advertisement.

The product specific information provided by user 110 may be stored in a memory device (e.g., memory 220 and/or database 250). Further, system 150 may also store profile information associated with user 110 in the memory device for notification purposes described below. For example, system 150 may maintain user profile information associated with various characteristics of user 110, such as age, income, credit report data, address information, interest profiles, purchase profiles, etc. Notification system 150 uses the stored profile information to determine a marketing value for user 110 that represents a likelihood of user 110 purchasing a particular product (Step 320).

In one embodiment of the invention, system 150 may perform a scoring process that analyzes the information included in a user's profile and the type of product the user is intending to purchase to compute a marketing value (e.g., a numerical data value) representing an indication of the likelihood of the user to purchase a comparable product offered by another manufacturer. For example, suppose user 110 is a 50 years old single male that lives in southern California, and receives a moderate to high level of income. Further suppose that notification system 150 determines that the exemplary user intends to purchase a high end vehicle provided by manufacturer 130-1, such as a Porsche™. Based on the exemplary user profile and product information, system 150 may determine that the exemplary user 110 is unlikely to purchase a minivan manufactured by a competing manufacturer, such as manufacturer 130-2 that system 150 is configured to provide marketing services. Accordingly, system 150 may compute a corresponding marketing value for the user reflecting this unlikelihood (e.g., a low marketing value, such as a 15 out of a scale of 1 to 100, where a 100 represents the highest likelihood of purchasing a comparable product and 1 represents the lowest likelihood to purchase the comparable product). Alternatively, an exemplary user that is a 30 year old married male with three children and receives a lower to moderate income may be associated with a marketing value that reflects a higher likelihood of purchasing the minivan provided by manufacturer 130-2 (e.g., a high marketing value, such as an 85 out of 100). One skilled in the art would appreciate that a number of different characteristics of a user's profile and a product may be used by notification system 150 to compute a marketing value without departing from the scope of the present invention.

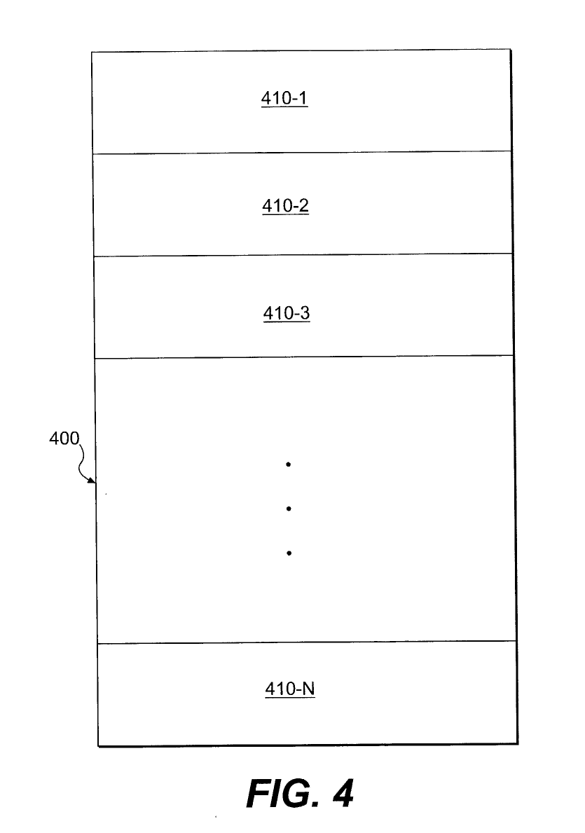

Once a marketing value has been determined for user 110, system 150 may then create and/or modify a ranking data structure that includes a structured arrangement of one or more users that have been scored. For instance, system 150 may create and/or maintain an arrangement of users (e.g., customers) that have been scored and rank them based on their corresponding marketing values, such as from highest to lowest scores. Accordingly, when user 110 is scored, the user may be added to the ranking data structure in the appropriate location based on the marketing value for the user. Alternatively, system 150 may collect a number of user marketing values prior to creating a ranking data structure. System 150 may also divide the ranking data structure into segments that each reflect various ranges of marketing values. FIG. 4 shows an exemplary ranking data structure 400 consistent with this embodiment of the present invention. As shown, data structure 400 is divided into N segments, where N is an integer value greater than zero. Segment 410-1 may include one or more users that have the best (e.g., highest) marketing values representing a higher likelihood of purchasing a product offered by a particular manufacturer or manufacturers.

Conversely, segment 410-N may include one or more users that have the lowest marketing values.

Once the ranking data structure is created and/or modified, system 150 may perform a marketing process that determines a type of offer and a type of channel (e.g., electronic medium, telephonic medium, etc.) to provide the offer based on one or more marketing computations (Step 330). An offer may be a notification that includes information on a product provided by a manufacturer that system 150 is configured to provide marketing services. The offer may include a purchase incentive which may not be otherwise available, unless, for instance, offered by system 150. The purchase incentive benefit may be a financial or non-financial benefit, such as a process benefit. A financial benefit may be a monetary based benefit, such as a monetary discount on a product, a free item (e.g., free trip to a resort), a fee upgrade on one or more options available for a comparable product, etc. A process benefit may be associated with a benefit that a recipient of the offer may receive that has an intangible or abstract value. For example, a process benefit may be an opportunity for the recipient of the offer to test drive a new vehicle that is generally unavailable to the public. Further, a process benefit may be a right to receive one or more special services unavailable to other users, such as the general public. For example, the process benefit may allow the recipient of the offer to receive special service or treatment when the recipient visits a particular business entity associated with a manufacturer of the product corresponding to the offer (e.g., first-class services, such as after hour services, quick processing services, etc.)

In one embodiment, system 150 determines a type of offer to provide to a user based on a calculated return value associated with each segment in the data structure. The return value may represent a monetary return value that system 150 may receive for providing one or more offers to a user included in the respective segment. For example, segment 410-1 may be associated with a return value of $140, which represents a return that system 150 will receive for providing an offer to a user included in segment 410-1. Further, segment 410-2 may be associated with a return value of $100, while segment 410-N may only have a return value of $25. Notification system 150 may determine a return value for each segment based on a number of different criteria. For instance, manufacturer 130-2 may have an agreement with notification system 150 to provide a payment for each offer provided by system 150 in a manner consistent with embodiments of the present invention. Based on the agreed payment, system 150 may determine the return value of providing an offer to a user in each segment of the ranking data structure.

In addition to return values, system 150 also determines a type of offer based on a cost of providing an offer to a user through various channels. For example, system 150 may determine that it would cost $100 to provide offers to users through a telemarketing medium, $50 to provide offers through a direct mail medium, and $25 to provide offers through an electronic medium, such as electronic mail and/or content provided on a web page. Further, system 150 may determine an effectiveness value for each channel. For instance, based on historical data, system 150 may determine that direct mail is a more effective channel for providing offers than telemarketing (e.g., more offers are accepted through direct mail than telemarketing). Accordingly, system 150 may determine and/or maintain effectiveness values for an offer for one or more products and corresponding channels of delivery.

Based on the determined return values, channel costs, effectiveness values, system 150 may determine a type of offer and a type of channel to provide the offer to user 110. For example, suppose segments 410-1 and 410-2 shown in FIG. 4 have return values of $140 and $100, respectively. Further suppose that the determined cost of delivering offers through telemarketing channels is $100 and the cost of delivering offers through direct mail channels is $50, which is also determined to be less effective than telemarketing for a particular product. Based on the above exemplary costs and values, notification system 150 may determine that the users included in segment 410-1 will receive offers through telemarketing channels and users in segment 410-2 will receive offers through direct mail channels.

In addition, or alternatively, to the determined values and cost data described above, system 150 may also determine the type of offer to provide a user (e.g., user 110) based on information associated with the offered product comparable to the product the user intends to purchase, the product the user intends to purchase, and/or the type of benefit (e.g., process and/or financial) associated with the offered product. Accordingly, an offer may include information on the type of product offered by a manufacturer and/or a purchase incentive associated with the offered product.

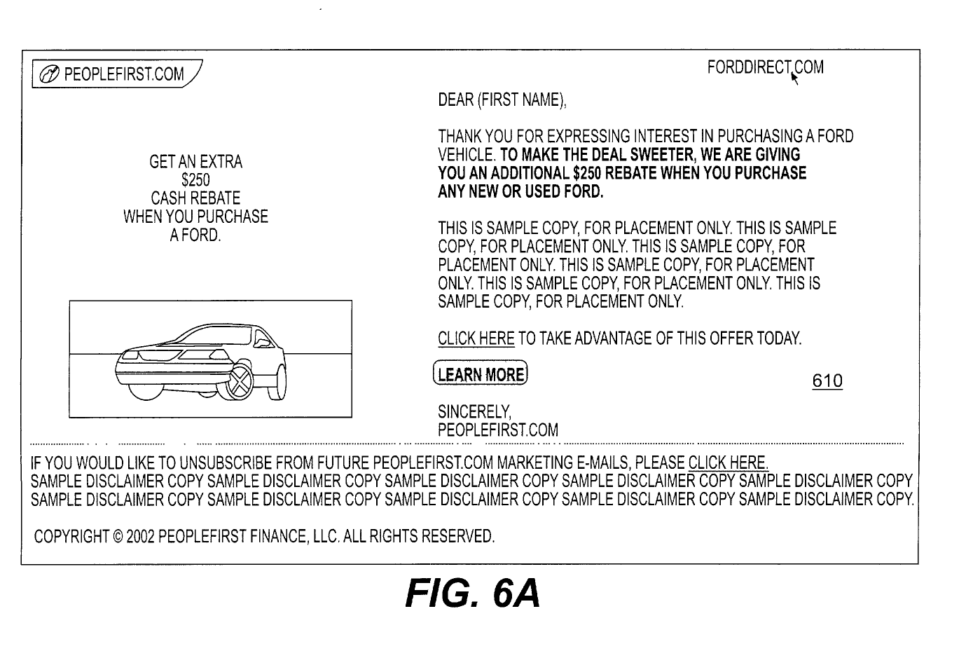

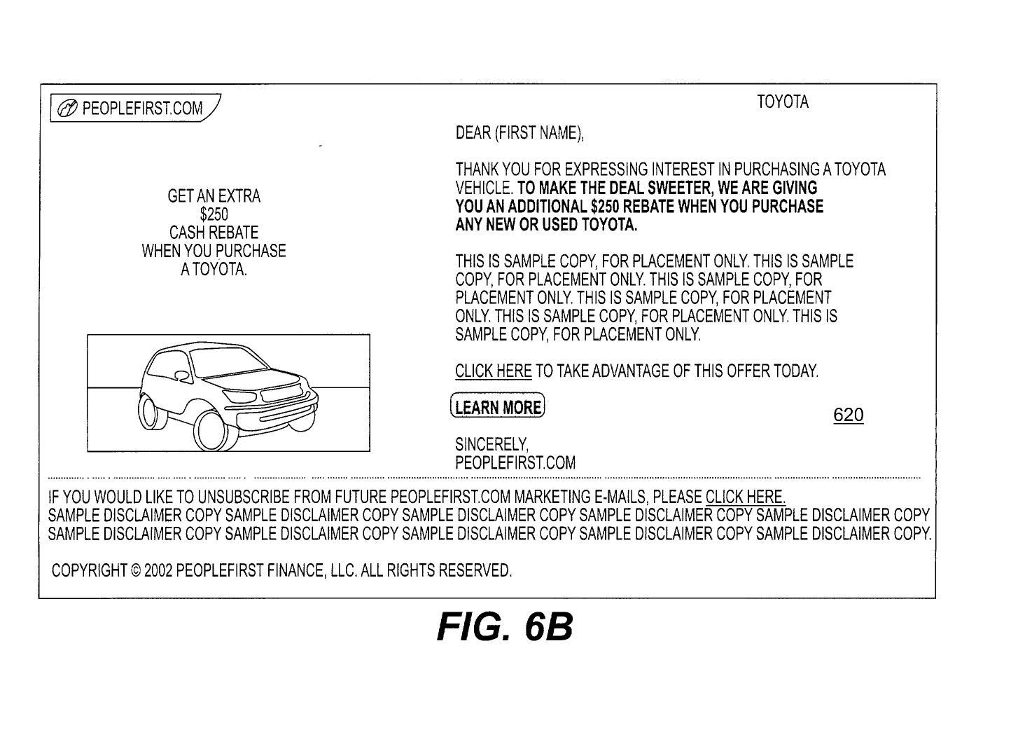

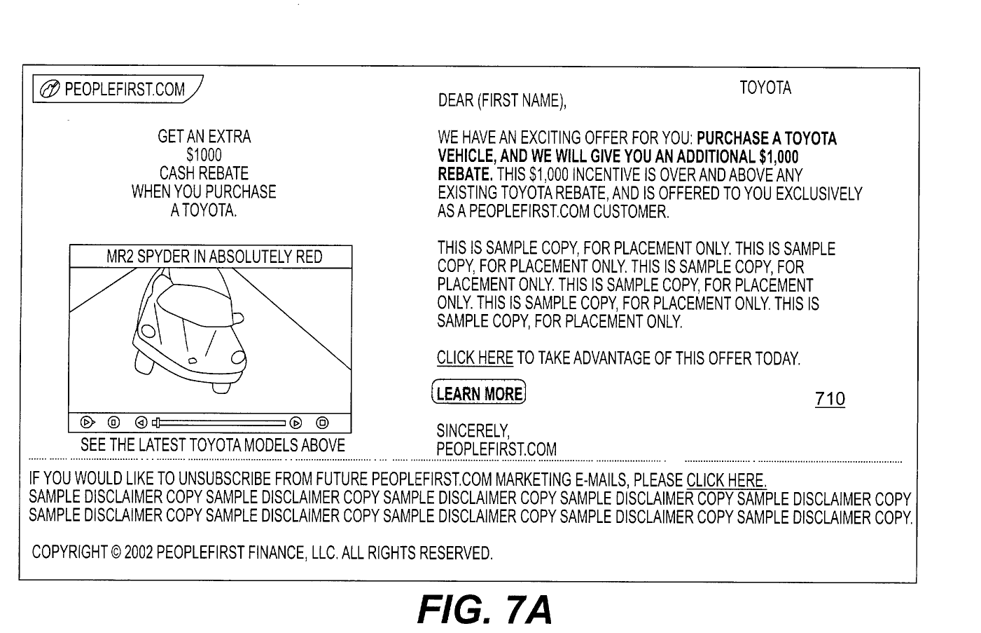

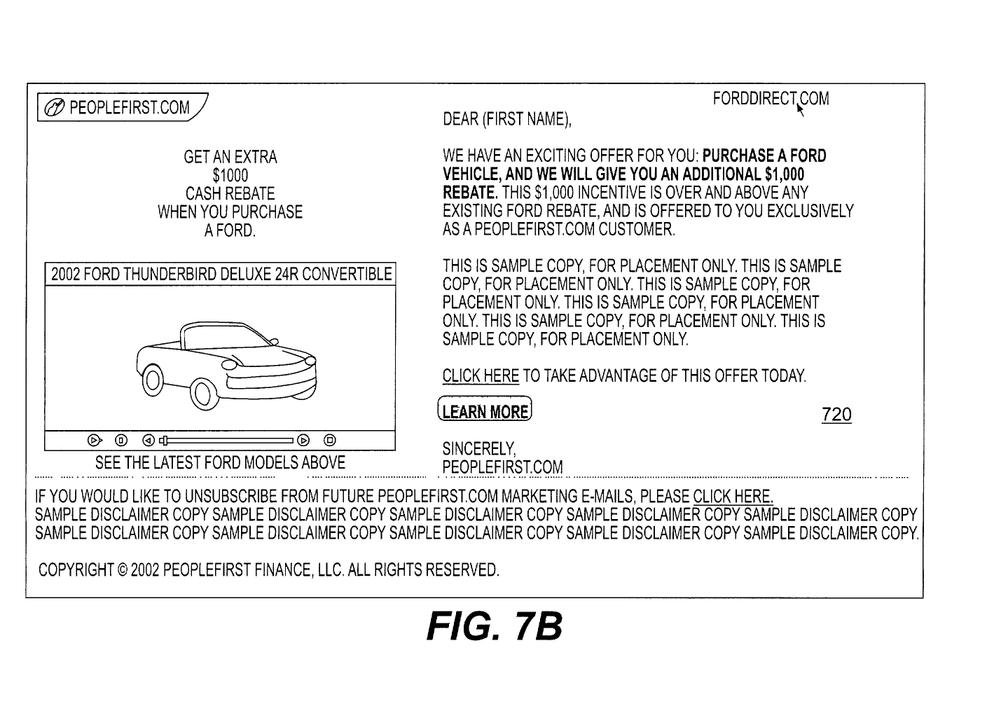

For example, suppose manufacturer 130-1 is associated with a manufacturer of vehicles, such as Ford™, and manufacturer 130-2 is associated with a competing manufacturer, such as Toyota™. Further suppose that that manufacturer 130-2 has agreed to provide payment to system 150 for each delivered offer associated with one or more products provided by manufacturer 130-2. Based on these exemplary circumstances, system 150 may determine a type of offer to provide to a user based on the type of product the user intends to purchase. For instance, if system 150 determines that user 110 intends to purchase a Ford vehicle, system 150 may generate and provide one type of offer for a Toyota vehicle. However, if the user 110 intends to purchase a Toyota, system 150 may generate and provide a different offer associated with Toyota vehicles. For example, the offer may include information regarding a discount on a purchase price for a particular vehicle that would otherwise not be available to the user 110. In one embodiment of the invention, system 150 may generate and provide brand reinforcement and conquest notifications including corresponding offers. These types of offers are described below with respect to FIGS. 6A through 7B.

FIGS. 6A and 6B show exemplary brand reinforcement notifications including offers reflecting discounts on products provided by particular manufacturers. Notification 610 of FIG. 6A may be generated and/or maintained by system 150 for manufacturer 130-1 (e.g., associated with Ford™) and notification 620 of FIG. 6B may be generated and/or maintained for manufacturer 130-2 (e.g., Toyota™). The brand reinforcement notifications 610 and 620 may be provided for the purpose of reinforcing product sales to a user that has the intention of purchasing a product produced by the same manufacturer. Therefore, if system 150 determines that user 110 intends to purchase a Ford™ vehicle, notification 610 may be offered as a candidate notification for manufacturer 130-1. Alternatively, if user 110 intends to purchase a Toyota™ vehicle, notification 620 may be offered as a candidate notification for manufacturer 130-2.

As explained, in addition to brand reinforcement notifications, notification system 150 may also generate and/or maintain conquest notifications. A conquest notification may be a notification that includes an offer associated with a product provided by a manufacturer and is created for the purpose of competing with a competitor's product. For example, FIGS. 7A and 7B show two exemplary conquest notifications. Notification 710 of FIG. 7A may be a notification generated and/or maintained by system 150 for manufacturer 130-2 (associated with Toyota™) and notification 720 of FIG. 7B may be generated and/or maintained for manufacturer 130-1 (associated with Ford™). Notification 710 may be provided by system 150 for presentation to a user that is determined to have an intention of purchasing a product other than one provided by manufacturer 130-2 while notification 720 may be provided for presentation to a user determined to have an intention of purchasing a product other than one provided by manufacturer 130-1. Therefore, notification system 150 may generate and/or maintain conquest notifications that are used for presentation to potential purchasers of competing products. The conquest notifications may include information associated with a particular product, including features, prices, and or discounts. In one embodiment, a conquest notification may include a message reflecting a discount offer to a user that would otherwise not be available to the user.

System 150 may be configured to generate and/or maintain a number of different types of notifications that include a number of different offers. For example, system 150 may generate an offer for various discounts on a product based on data included in a loan application completed by user 110. Alternatively, system 150 may generate a offer based on information associated with different types of products comparable to the product user 110 intends to purchases (e.g., notification of a four wheel drive truck provided by manufacturer 130-2 when user 110 intends to purchase a four wheel drive truck from manufacturer 130-1). In one embodiment of the invention, the notifications maintained and/or generated by system 150 may include offers that include a benefit (financial or non-financial) that is not available to the general public (e.g., users that have not accessed, registered, or interacted with notification system 150 and/or a business entity associated with notification system 150).

Once system 150 determines the appropriate offer and type of channel for user 110, the offer is configured in a format associated with the determined channel and provided to user 110 (Step 340). In one embodiment of the invention, notification system 150 may format an offer based on the selected channel and other marketing rules, such as presentation rules associated with various categories of a selected channel. For example, system 150 may determine a format of an offer based on criteria associated with the manufacturer corresponding to the notification, the user being notified, and/or the type of notification. For instance, system 150 may be configured to override a marketing decision to use a selected channel based on a manufacturer's request to have offers for its products provided through a predetermined channel. Thus, manufacturer 130-1 may request that system 150 provides an offer to a user in an e-mail message. Alternatively, manufacturer 130-1 may request that the user is notified telephonically. Further, manufacturer 130-1 may request that the user is notified by a document mailed to the user through conventional mail services. System 150 and/or the business entity associated with system 150 may be configured to include the necessary infrastructure to perform any of the above exemplary notification procedures (e.g., customer service center, mailing services, e-mail services, etc.).

System 150 may access the previously stored identification and contact information associated with user 110 in order to locate and provide the appropriate one or more notifications including an offer to user 110. In one embodiment, system 150 may configure an e-mail message that includes a file that presents the notification in graphical and/or textual form. For example, system 150 may send user 110 an e-mail message that includes a notification similar to notifications 610, 620, 710, or 720. Alternatively, the e-mail message may include a link to a web page that includes a notification similar to notifications 610, 620, 710, or 720. One skilled in the art would appreciate that user 110 may be provided with other notifications based on the type of product and/or service offered by a manufacturer purchasing one or more segments, in one or more product indices, without departing from the scope of the invention.

In addition to providing notifications with corresponding offers to one or more users, system 150 may also perform a monitoring process that tracks the number of provided notifications and charges a corresponding fee to a manufacturer associated with that number. FIG. 8 shows a flowchart of an exemplary monitoring process consistent with an embodiment of the present invention. Notification system 150 may track each notification provided to a user, and associated with a manufacturer that requested marketing services from system 150 consistent with embodiments of the present invention (Step 810). The tracked notifications may be correlated with the corresponding manufacturer and, based on the type of notification(s) provided, system 150 may determine an appropriate fee to charge each corresponding manufacturer (Step 820). For example, system 150 may charge one type of fee for an e-mail notification and another type of fee for a telephonic notification. System 150 may track notifications and process fees periodically or as the notifications are provided to the users. For instance, system 150 may be configured to determine the fees to charge each manufacturer on an hourly, daily, weekly, etc. basis. Once the appropriate fees are determined for each manufacturer, system 150 may generate an invoice for billing each manufacturer and provide the invoices to the manufactures periodically (e.g., weekly, monthly, etc.) (Step 830). The manner in which system 150 determines fees and charges a manufacturer is not limited to the process described above. For instance, the business entity associated with notification system 150 may allow a manufacturer to pay a flat fee prior to a notification being provided to user 110. Alternatively, the business entity may charge a manufacturer a service fee and/or a fee based on each notification.

As described, embodiments of the present invention enable a manufacturer to increase its sales volume at the expense of a competitor, obtain access to a large number of potential purchasers, offer financial benefits to potential customers without losing financial values to pre-existing customers, and/or provide brand reinforcement notifications to pre-existing customers. Further, embodiments of the present invention enable a customer (e.g., user 110) to receive financial benefits (e.g., discounts of sales price, lower interest rates, fee upgrades, third party offers such as a free cruise or plane ticket, etc.) that are not available to the general public. A customer may also receive the benefits without communicating with agents from a manufacturer, and/or receive the benefits with a limited amount of effort (e.g., filling out extra fields in a loan application, filling out a survey etc.). Also, embodiments of the present invention enable a business entity associated with notification system 150 to generate additional advertising revenue by charging fees for providing the notifications and/or possibly gain additional customers through the ability to offer a user one or more financial benefits (e.g., discounts) offered by existing or competing manufacturers of products they intend to purchase.

Other embodiments of the invention will be apparent to those skilled in the art from consideration of the specification and practice of the invention disclosed herein. For example, system 150 may generate and/or maintain a of ranking data structures for each type of a plurality of products provided by a manufacturer. Accordingly, system 150 may rank the users in the data structure, and divide the structure into appropriate segments based on the type of product corresponding to the respective ranking data structure. Further, in another embodiment, the marketing value determined by system 150 may be configured to reflect a likelihood of the user purchasing the first product the user intends to purchase instead of the offered product that is comparable to the first product. For instance, based on information reflecting a user's intention to purchase a first product, system 150 may analyze the user's profile information and information associated with the first product to determine a marketing value for the user. Accordingly, the marketing value may reflect a likelihood of the user purchasing the first product. Thus, for example, if this likelihood is very high (or very low), system 150 may determine a different type of offer to provide to the user.

It is intended that the specification and examples be considered as exemplary only, with a true scope and spirit of the invention being indicated by the following claims. Furthermore, although embodiments of the present invention are described as being associated with data stored in memory and other storage mediums, one skilled in the art will appreciate that these aspects can also be stored on or read from other types of computer-readable media, such as secondary storage devices, like hard disks, floppy disks, or CD-ROM; a carrier wave from the Internet; or other forms of RAM or ROM. Accordingly, the invention is not limited to the above described embodiments, but instead is defined by the appended claims in light of their full scope of equivalents.

What is claimed is:

1. A method for providing offers associated with an offered product to a user, comprising:
determining whether the user may purchase a first product;
determining a marketing value associated with the user, wherein the marketing value indicates a likelihood of the user purchasing the offered product;
generating an offer associated with the offered product, which is comparable to the first product, based on the marketing value; and
providing the offer to the user, wherein the offer includes a purchase incentive which may not otherwise be available to the user.

2. The method of claim 2, wherein determining whether the user may purchase the first product includes:
receiving an indication that the user is considering to purchase the first product.

3. The method of claim 2, wherein the indication is received through at least one:
(i) an electronic medium,
(ii) a telephonic-based medium, and
(iii) a conventional mail medium.

4. The method of claim 2, wherein receiving an indication includes:
receiving an indication reflecting information provided by the user on an electronic document.

5. The method of claim 2, wherein the indication is included in at least one of:
(i) a loan application corresponding to the first product, and
(ii) information provided by a third party source.

6. The method of claim 1, wherein determining a marketing value associated with the user includes:
determining a marketing value for the user based on at least one of user profile information and information associated with the first product, wherein the marketing value represents a likelihood of the user purchasing the first product.

7. The method of claim 6, wherein determining a marketing value associated with the user further includes:
associating the user with one of a plurality of segments in a ranking data structure based on the marketing value, wherein each segment is associated with one or more other users with corresponding marketing values.

8. The method of claim 7, wherein determining a marketing value associated with the user further includes:
determining a return value for each of the segments, wherein each return value represents a monetary value that may be received if the offer is provided.

9. The method of claim 8, wherein generating the offer associated with the offered product includes:
generating the offer based on at least one of the marketing value, the return value associated with the segment corresponding to the user, and a cost of providing the offer to the user through a particular channel.

10. The method of claim 9, wherein the particular channel includes one of an electronic medium, a conventional mail services medium, and a telephonic medium.

11. The method of claim 1, wherein providing the offer includes:
providing an e-mail message to the user including content reflecting the offer associated with the offered product.

12. The method of claim 1, wherein providing the offer to the user includes:
providing a message including the offer associated with the offered product to the user, wherein the message is at least one of:
(i) an e-mail message,
(ii) a telephonic message, and
(iii) a paper based message.

13. The method of claim 1, wherein the benefit is one of a financial benefit and a process benefit.

14. The method of claim 13, wherein the financial benefit is one of a discount on a sale price of the offered product, an offer for a free product and/or service associated with a third party, a reduction in an interest rate corresponding to a financial loan for purchasing the offered product, and a free upgrade in additional features that may be available for the offered product.

15. The method of claim 13, wherein the process benefit is associated with a service that is not available to other users.

16. The method of claim 13, wherein the process benefit is one of an opportunity for the user to receive a service that is not available to other users, and an opportunity for the user to visit a business entity that provides the offered product during a time of day that one or more other users may not visit the business entity.

17. The method of claim 1, further including:
tracking a number of offers provided to the user; and
charging a merchant of the offered product a fee based on the number of provided offers.

18. The method of claim 1, further including:
tracking a number of offers associated with the offered product provided to a plurality of users; and
charging a merchant of the offered product a fee based on the number of provided offers.

19. The method of claim 1, wherein the first product is provided by a first manufacturer and the offered product is provided by a second manufacturer.

20. The method of claim 1, wherein the first and offered products are provided by a manufacturer.

21. A system for providing an offer to a user, comprising:
a memory including:
first program code configured to determine whether the user may purchase a first product,
second program code configured to a determine a marketing value associated with the user, wherein the marketing value indicates a likelihood of the user purchasing an offered product which is comparable to the first product,
third program code configured to generate an offer associated with the offered product based on the marketing value, and
fourth program code provide the offer to the user, wherein the offer includes a purchase incentive which may not otherwise be available to the user;
a processor for executing the first through fourth program code.

22. The system of claim 21, wherein the memory further includes:
fifth program code configured to track a number of offers provided to the user; and
sixth program code for charging a manufacturer of the offered product a fee based on the number of offers.

23. The system of claim 21, wherein the second program code configured to determine a marketing value associated with the user includes:
program code configured to determine the marketing value associated with the user based on at least one of user profile information and information associated with the first product, wherein the marketing value represents a likelihood of the user purchasing the offered product.

24. The system of claim 23, wherein the second program code configured to determine a marketing value associated with the user further includes:
program code configured to associate the user with one of a plurality of segments in a ranking data structure based on the marketing value, wherein each segment is associated with one or more other users with corresponding marketing values.

25. The system of claim 24, wherein the second program code configured to determine a marketing value associated with the user further includes:
program code configured to determine a return value for each of the segments, wherein each return value represents a monetary value that may be received if the offer is provided.

26. The system of claim 25, wherein the third program code configured to generate an offer associated with the offered product includes:
program code configured to generate the offer based on at least one of the marketing value, the return value associated with the segment corresponding to the user, and a cost of providing the offer through a particular channel.

27. The system of claim 26, wherein the particular channel includes one of an electronic medium, a conventional mail services medium, and a telephonic medium.

28. A system for providing an offer to a user, comprising:
a first computer system configured to provide information associated with a determination whether a user may purchase a first product; and
a second computer system configured to determine a marketing value for the user representing a likelihood of the user purchasing a second product which is comparable to the first product, generate an offer for the second product based on the marketing value, and provide the offer to the first computer system, wherein the offer includes information associated with purchase incentive which may not otherwise be available to the user.

29. The system of claim 28, wherein the first computer system provides the intention information via an electronic document that includes one or more queries for information on various characteristics of the first product the user may purchase.

30. The system of claim 28, wherein the second computer includes a data structure that contains a plurality of segments, wherein each segment is associated with one or more users having a corresponding marketing value representing a likelihood of the respective user purchasing the second product.

31. The system of claim 30, wherein the second computer is configured to associate the user with one of the plurality of segments based on at least one of profile information for the user and information associated with at least one of the first and second product.

32. The system of claim 29, wherein the electronic document is a loan application that is completed by the user.

33. The system of claim 28, wherein the second computer is configured to determine a marketing value for the user based on at least one of user profile information and information associated with at least one of the first and second product.

34. The system of claim 28, wherein the second computer is configured to associate the user with one of a plurality of segments in a ranking data structure based on the marketing value, wherein each segment is associated with one or more other users with corresponding marketing values.

35. The system of claim 34, wherein the second computer is configured to determine a return value for each of the segments, wherein each return value represents a monetary value that may be received if the offer is provided.

36. The system of claim 35, wherein the second computer is configured to generate the offer based on at least one of the marketing value, the return value associated with the segment corresponding to the user, and a cost of providing the offer through a particular channel.

37. The system of claim 36, wherein the particular channel includes one of an electronic medium, a conventional mail services medium, and a telephonic medium.
